(19) United States
(12) Patent Application Publication
(10) Pub. No.: US 2015/0244102 A1
(43) Pub. Date: Aug. 27, 2015

(54) Underwater Electronics Connector and Methods

(71) Applicant: Daniel J. Braun, San Diego, CA (US)

(72) Inventor: Daniel J. Braun, San Diego, CA (US)

(73) Assignee: United States of America, as Represented by the Secretary of the Navy, Arlington, VA (US)

(21) Appl. No.: 14/186,032

(22) Filed: Feb. 21, 2014

(51) Int. Cl. H01R 13/523; H01R 43/26; H01R 13/50

(52) U.S. Cl. CPC H01R 13/523; H01R 13/50; H01R 43/26

(57) ABSTRACT

An underwater connection system and methods can include a male connector having a proximal end and a distal end and a female connector having a proximal end and a distal end. At least one of the male connector or the female connector can have an increasing taper when viewed in top plan, from a minimum width at its distal end to a maximum width at its proximal end. To do this, the male or female connector can be formed with a surrounding rubber housing. The rubber housing can be formed with a wedge that is integral to the rubber housing to establish the increasing taper. The taper can be linear or curved, according to the needs of the user, and either or the male connector or female connector can be inline or right-angle connectors, according to the system design and space constraints.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc pac t2@navy.mil, referencing NC 101808.

### FIELD OF THE INVENTION

The present invention pertains generally to electrical connectors. More specifically, the present invention pertains to underwater electrical connectors. The invention is particularly, but not exclusively, useful as an underwater electrical connector with structure that can facilitate disconnection after the connectors has been assembled for an extended time, while at the same time maintaining a minimum profile for the connector.

### BACKGROUND OF THE INVENTION

Underwater electrical/electronics connectors (in the specification, the terms “electrical” and “electronics” are interchangeable and can be taken to mean the same thing) can be essential for transmitting power and data across dry, flooded, and water exposed sections of underwater equipment. Low profile, right angle and inline, wet mateable underwater connectors can be used in cases where clearance is limited, or where low system volume or small connector profile is a requirement. These types of connectors can be simple to assemble and deploy.

Although these types of connectors can be simple and easy to deploy, they are often not so simple and easy to retrieve. Disassembly of the male and female ends of this type of connector that have previously been deployed underwater or that have been connected for long periods of time tend to be very difficult to separate, as there can be minimal surface area to hold on to. Additionally, marine growth may have fouled the connector, which can make it difficult to grip the connector for separation.

Still further, the exteriors of both the male and female sides of the connector can be manufactured from smooth rubber, which can prevent the operator from being able to separate the two parts. When the connector is stuck, operators will often wrongly use a flat screw driver to pry the ends of the connector apart. This could easily damage the connector body. In the case of right angle connectors, improper disassembly can result in putting a torque on the body of the connector or rotating the seal and threads, which rigidly fasten the connector and create a watertight seal.

In view of the above, it is an object of the present invention to provide an underwater electrical connector having structure that can prevent the operators finger's from slipping off the connector during disassembly. Yet another object of the present invention is to provide an underwater electrical connector that can provide the operator with an improved surface for disassembling the male and female ends of the connector. Still another object of the present invention is to provide an underwater electrical connector that, in the case of right angle connectors, can allow the operator to rotate the seal and threads of the connector with sufficient torque to create a watertight seal for the connector. Another object of the present invention is to provide an underwater electrical connector that allows for disassembly without the use of tools. Yet another object of the present invention is to provide an underwater electrical connector having structure that facilitates disassembly, while at the same time only minimally increasing the overall profile of the connector body. Another object of the present invention is to provide an underwater electrical connector that can be easy to manufacture and use in a cost-efficient manner.

### SUMMARY OF THE INVENTION

An underwater connection system and methods can include a male connector having a proximal end and a distal end, and a female connector having a proximal end and a distal end. At least one of the male connector or the female connector can have an increasing taper when viewed in top plan from a minimum width at its distal end to a maximum width at its proximal end. To do this, the male or female connector can be formed with a surrounding rubber housing. The rubber housing can be formed with a wedge that is integral to the rubber housing to establish the increasing taper. The taper can be linear or curved, according to the needs of the user, and either or the male connector or female connector can be inline or right-angle connectors, according to the system design and space constraints.

### BRIEF DESCRIPTION OF THE DRAWINGS

The novel features of the present invention will be best understood from the accompanying drawings, taken in conjunction with the accompanying description, in which similarly-referenced characters refer to similarly-referenced parts, and in which:

FIG. 1 is a top plan view an underwater electrical connection system of the present invention according to several embodiments;

FIG. 2 is side plan view of the system of FIG. 1;

FIG. 3 is a side elevational view of the system of FIG. 1 when the male and female ends are disconnected;

FIG. 4 is the view as FIG. 3, but with the male and female ends connected;

FIG. 5 is a top plan view of the system of FIG. 4; and,

FIG. 6 is a block diagram, which illustrates steps that can be taken to accomplish the methods of the present invention according to several embodiments.

### DETAILED DESCRIPTION OF THE EMBODIMENTS

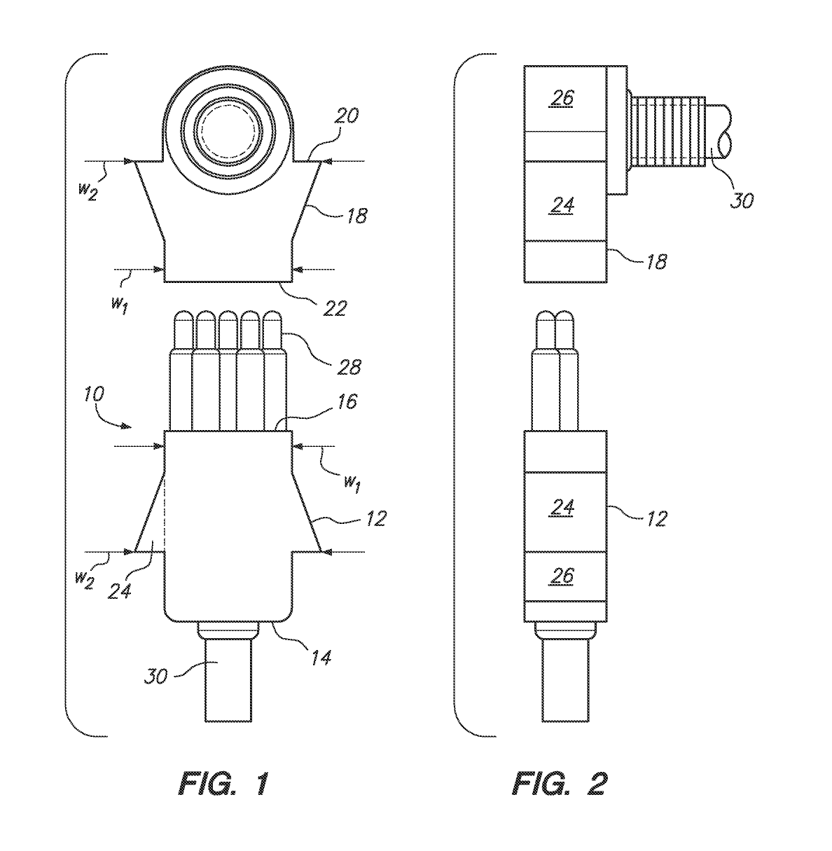

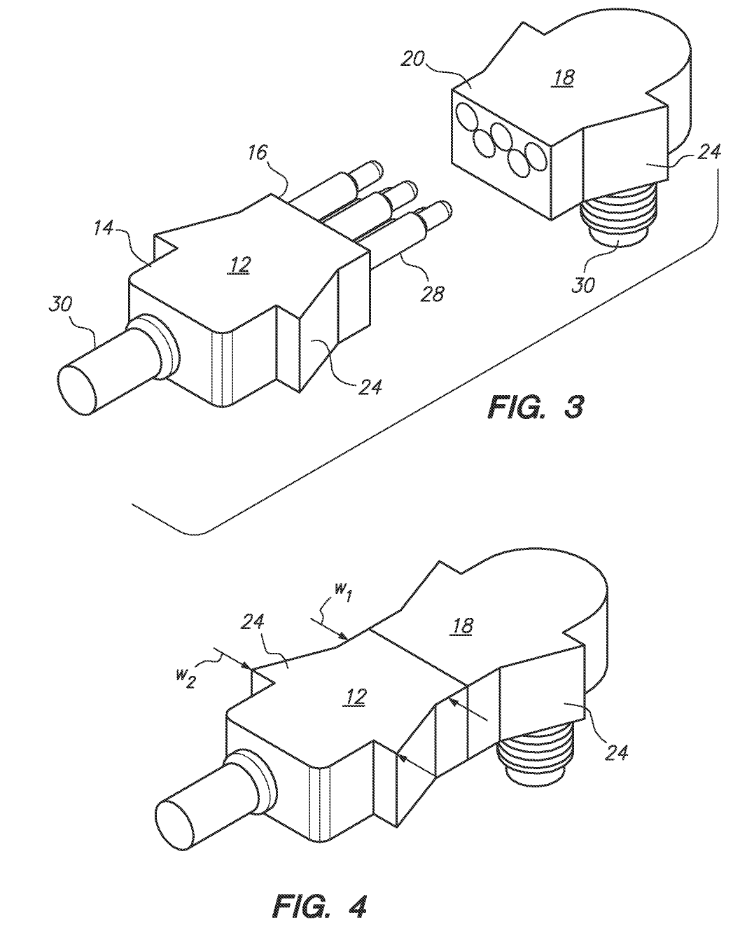

Referring initially to FIGS. 1-3, an improved underwater electronics connection system according to several embodiments of the present invention is shown and is generally designated by reference character 10. As shown in FIGS. 1-3, system 10 can include a male connector 12 with a proximal end 14 and distal end 16, and a female connector 18 having a proximal end 20 and a distal end 22.

Either of the male connector 12 or the female connector 18 can be formed with a decreasing wedge 24, as shown in FIGS. 1-3. With this configuration, the male connector can have an increasing taper when viewed in top plan from a minimum width w₁ at distal end 16 to a maximum width w₂ near proximal end 14. Similarly, female connector 18 can have an increasing taper when viewed in top plan from a minimum width w₁ at distal end 22 to a maximum width w₂ near proximal end 20.

The wedge 24 can be attached to rubber housing 26 using glue or other means known in the art, or alternatively rubber housing 26 can be manufactured so that wedge 24 is integral to the housing (i.e. the connector itself can have the increasing taper when viewed in top plan. The wedge 24 has be formed so that the taper is linear, as shown in FIGS. 1-5, or the wedge can be curved or arcuate when viewed in top plan (not shown in the Figs.), or have any other ergonomic contour when viewed in top plan, according to the needs of the user. As shown in FIGS. 1-3, the rubber housing 26 can surround the electrical structure 28, to protect the electrical portion of the system 10 from the elements.

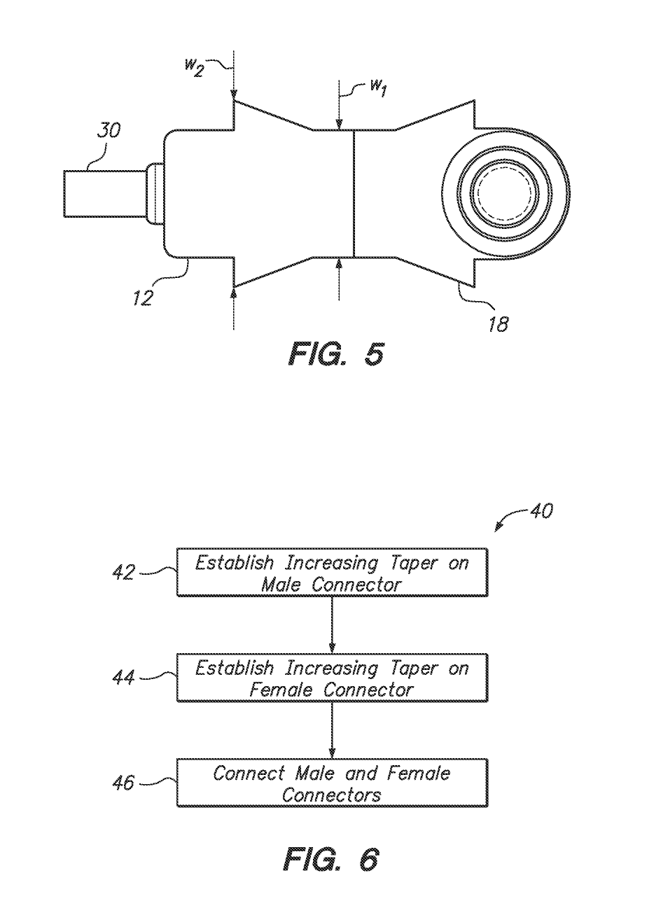

Referring now to FIGS. 4-5 the system 10 is illustrated when male half 12 is connected to female half 18. When the connected, the wedges 24 can allow for the user to more easily grip the male half 12 and female half 18 to disconnect the two halves 12, 18. At the same time, the overall profile for the system 10 remains minimized, in the event there is not a lot of clearance at the location where the connection is to be established. As shown in FIGS. 1-5, the male connector 12 can be an inline connector (cord 30 is inline with the electrical structure 28), while the female connector 18 can be a right angle connector 14 (cord 30 is at right angles to the electrical structure). It should be appreciated, however, that either or both of the male connector 12 or female connector 18 could be inline connection systems or right angle connection systems, according to the clearance constraints and the needs of the user.

Referring now to FIG. 6, a block diagram 40 can be used to describe the methods of establishing an underwater electrical connection for the present invention according to several embodiments. As shown, method 40 can include the initial step 42 is establishing an increasing taper on male connector 12. The taper can establish a minimum width w₁ at distal end 16 of male connector 12 and a maximum width w₂ near proximal end 14 of male connector 12, as described above. Next, the step of establishing an increasing taper on female connector 18 can be accomplished, as shown by box 44 in FIG. 6. When this step is accomplished, female connector 18 can have an increasing taper when viewed in top plan from a minimum width w₁ at distal end 22 to a maximum width w₂ near proximal end 20, as also described above. Finally, the methods can include connecting male connector 12 to female connector 18, as shown by step 46 in FIG. 6.

The use of the terms “a” and “an” and “the” and similar references in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A connection system, comprising:
a male connector having a proximal end and a distal end;
a female connector having a proximal end and a distal end; and,
at least one of said male connector or said female connector having an increasing taper when viewed in top plan from a minimum width at said distal end to a maximum width at said proximal end.

2. The system of claim 1 wherein both of said male connector and said female connector have said increasing taper.

3. The system of claim 1 wherein said male connector has a surrounding rubber housing, said rubber housing being formed with a wedge that is integral to said rubber housing to establish said increasing taper.

4. The system of claim 1 wherein said female connector has a surrounding rubber housing, said rubber housing being formed with a wedge that is integral to said rubber housing to establish said increasing taper.

5. The system of claim 1, wherein said male connector and said female connector are chosen from the group consisting of inline and right-angle connectors.

6. The system of claim 2 wherein said increasing taper for said male connector and for said female connector is linear.

7. An underwater electrical connector, comprising:
a male half having a proximal end and a distal end and an exterior rubber housing;
a female half having a proximal end and a distal end and an exterior housing; and,
at least one of said male half or said female half having a decreasing wedge attached thereto, to establish a decreasing taper for said at least one of said male half or said female half from a maximum width at said proximal end to a minimum width at said distal end, when said at least one of said male half or said female half is viewed in top plan.

8. The connector of claim 7 wherein both of said male half and said female half have said decreasing wedge and said decreasing taper.

9. The connector of claim 7 wherein said male half has a surrounding rubber housing and said decreasing wedge is integral to said rubber housing to establish said decreasing taper.

10. The connector of claim 7 wherein said female half has a surrounding rubber housing and said decreasing wedge is integral to said rubber housing to establish said decreasing taper.

11. The connector of claim 7, wherein said male half and said female half cooperate to establish an inline said connector.

12. The connector of claim 7, wherein said male half and said female half cooperate to establish an right-angle said connector.

13. The system of claim 8 wherein said decreasing taper for said male half and for said female half is linear.

14. A method for establishing an underwater connection, said underwater connection having a male connector and a female connector, said method comprising the steps of:
A) establishing an increasing taper on said male connector, said male connector having a proximal end and a distal end, said increasing taper increasing from a minimum width at said distal end to a maximum width at said proximal end when said male connector is viewed in top plan;
B) establishing an increasing taper on said female connector, said female connector having a proximal end and a distal end, said increasing taper increasing from a minimum width at said distal end to a maximum width at said proximal end when said female connector is viewed in top plan; and,
C) connecting said distal end of said male connector to said distal end of said female connector.

15. The method of claim 14 wherein said step A) is accomplished by surrounding said male connector with a rubber housing, said rubber housing being formed with a wedge that is integral to said rubber housing to establish said increasing taper.

16. The method of claim 15 wherein said step B) is accomplished by surrounding said female connector with a rubber housing, said rubber housing being formed with a wedge that is integral to said rubber housing to establish said increasing taper.

17. The method of claim 16, wherein said step A) and said step B) are accomplished using a said male connector and a said female connector that are chosen from the group consisting of inline and right-angle connectors.
